(19) United States
(12) Patent Application Publication
(10) Pub. No.: US 2026/0107042 A1
(43) Pub. Date: Apr. 16, 2026

(54) METHODS, DEVICES, AND SYSTEMS FOR LOCATION-BASED AD INSERTION

(71) Applicant: Comcast Cable Communications, LLC, Philadelphia, PA (US)

(72) Inventor: Ganesh NARAYANAN, Chennai (IN)

(21) Appl. No.: 18/912,257

(22) Filed: Oct. 10, 2024

(51) Int. Cl. H04N 21/81; H04N 21/234; H04N 21/845

(52) U.S. Cl. CPC H04N 21/812; H04N 21/234; H04N 21/8456

(57) ABSTRACT

Systems, devices, and methods for location-based content transmission and ad insertion are described herein. A playback device may play content and may determine its location in relation to a targeted object, such as a geographic location, traffic light, toll booth, etc. Based on the location data, the playback device may determine an available time duration for playback of content or an ad until it reaches the targeted object. The playback duration may correspond with an optimal time for an end user to attentively view the ad.

### BACKGROUND

Content may be provided to end users as a combination of content segments, which may include media requested or desired for playback by a playback device, and advertisement slots containing one or more ad segments. In some cases, a playback device may be portable or mobile, such that the playback device may change position before, during, or after playing back content. Further, some environmental scenarios of the playback device may allow for more optimal playback of advertisements. These and other shortcomings are identified and addressed in this disclosure.

### SUMMARY

Systems, devices, and methods for location-based ad insertion are described herein. A playback device may play a content. The playback device may determine its proximity to a targeted object, such as a traffic light or toll booth. Based on the proximity data, the playback device may determine a length of an ad or ad segments for inserting into the content for playback. The duration of the ad or ad segments may optimize advertisement playback while the playback device is in proximity to the targeted object. For example, in the case of the traffic light, the duration of the ad may correspond to an estimated time the playback device is near the traffic light.

In some cases, the playback device may dynamically insert an ad based on the proximity data and status data of the targeted object. Following the traffic light scenario, the playback device may receive information indicative of the traffic light displaying a red light, for example. The playback device may determine to dynamically insert an ad into the content while the traffic light is displayed. The proximity and status of the targeted object may correspond to an end user's level of attention to the played back content. With regards to the traffic light scenario, the playback device may be at a traffic stop caused by a red light of the traffic light. By playing dynamically placed ads, and ads having a duration based on how long the traffic stop will last, the playback device may optimize the likelihood the end user is attentively watching the inserted ads.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The following drawings show generally, by way of example, but not by way of limitation, various examples discussed in the present disclosure. In the drawings:

FIG. 1 shows an example system.

FIGS. 2A and 2B show an example system.

FIG. 3 shows an example computing device.

FIG. 4 shows an example method.

FIG. 5 shows an example method.

FIG. 6 shows an example method.

### DETAILED DESCRIPTION OF ILLUSTRATIVE EMBODIMENTS

Systems, devices, and methods for location-based ad insertion are described herein. A playback device may be capable of dynamically adjusting an ad duration for a content based on the playback device's location in relation to another object. For example, the playback device may be in an automobile, and the other object may be a traffic light. The automobile may be at a traffic stop caused by the traffic light. The playback device may receive information indicative of this traffic stop, and may determine an ad duration for an ad of the content based on this information. The ad duration may be based on the time the end user is in the traffic stop, which may maximize the likelihood the end user is paying attention to the ad. Similarly, the playback device may be capable of dynamically inserting an ad into the content based on a status of the object. Following the traffic light scenario, the playback device may receive information the traffic light is in a red light status, which may cause the traffic stop. The playback device may dynamically insert an ad into the content during this status for the object. As the end user may be experiencing this traffic stop, dynamically inserting the ad during the traffic stop may maximize the likelihood the end user is paying attention to the ad.

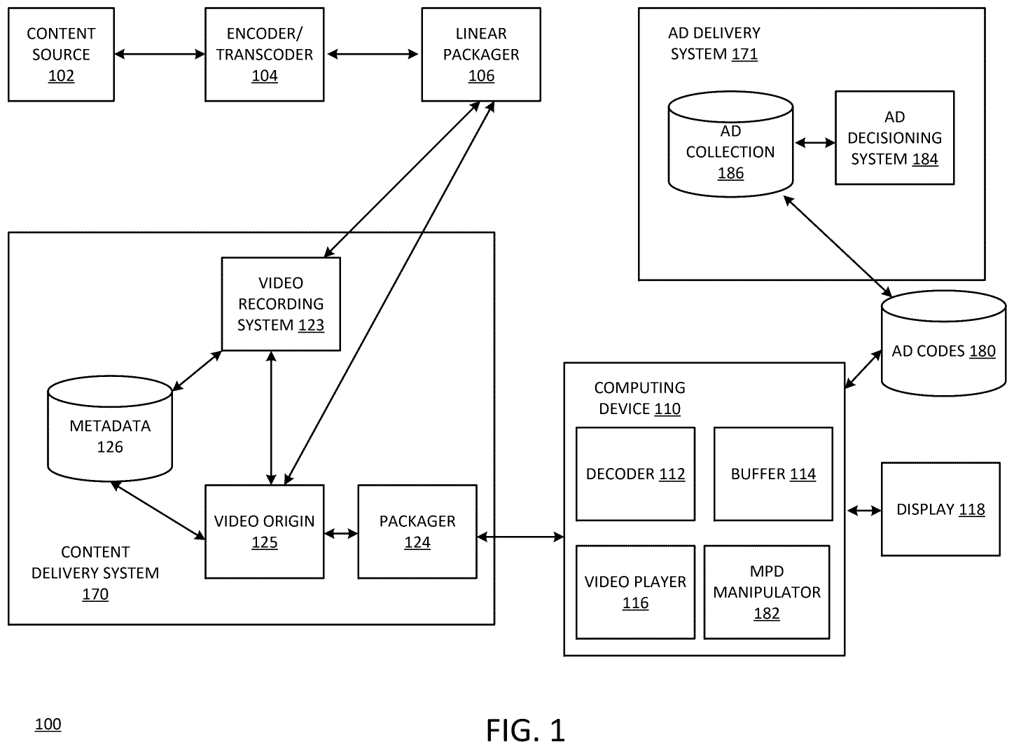

FIG. 1 shows system 100 for delivering content. The example system 100 may comprise a content source 102, an encoder/transcoder 104, a linear packager 106, a content delivery system 170, a storage system 171, an ad code database 180, and a computing device 110. The techniques for video processing described herein are applicable to any content delivery method including but not limited to Dynamic Adaptive Streaming over HTTP (DASH), HTTP Live Streaming (HLS), the quadrature amplitude modulation (QAM) standard, and/or adaptive bit rate (ABR) streaming.

The computing device 110 may comprise a television, a monitor, a laptop, a desktop, a smart phone, a set-top box, a streaming-video player, a cable modem, a gateway, a tablet, a wearable computing device, a mobile computing device, any computing device configured to receive and/or render content, the like, and/or any combination of the foregoing. The computing device 110 may comprise a decoder 112, a buffer 114, and a video player 116. The computing device 110 (e.g., the video player 116) may be communicatively connected to a display 118. The display 118 may be a separate and discrete component from the computing device 110, such as a television display connected to a set-top box. The display 118 may be integrated with the computing device 110. The decoder 112, the video player 116, the buffer 114, and the display 118 may be realized in a single device, such as a laptop or mobile device. The decoder 112 may decompress/decode encoded video data. The encoded video data may be received from the encoder/transcoder 104, the linear packager 106, or the content delivery system 170.

The content source 102 may comprise a source feed of content from a provider. For example, the content source 102 may comprise a broadcast source, a service provider (e.g., a cable television service provider), a headend, a video on-demand server, a cable modem termination system, the like, and/or any combination of the foregoing. The content source 102 may send content to the encoder/transcoder 104. The content may comprise for example, a program, a television show, a movie, a sports event broadcast, or the like. The content may comprise video frames or other images. For example, the content may comprise video frames in a Moving Picture Experts Group (MPEG) Single Program Transport Stream (MPEG-SPTS). The video frames may comprise pixels. A pixel may comprise the smallest controllable element of a video frame. The video frame may comprise bits for controlling each associated pixel. A portion of the bits for an associated pixel may control a luma value (e.g., light intensity) of each associated pixel. A portion of the bits for an associated pixel may control one or more chrominance value (e.g., color) of the pixel.

The content source 102 may receive requests for the content from the encoder/transcoder 104, the packager 106, the computing device 110, or the content delivery system 170. The content source 102 may send content to the encoder/transcoder 104 based on a request for video from the encoder/transcoder 104, the packager 106, the computing device 110, and the like. The content may comprise uncompressed video data or a content stream such as an MPEG-SPTS.

The encoder/transcoder 104 may comprise an encoder, which may encode uncompressed video data received from the content source 102. The terms transcoder and encoder may be used interchangeably herein. The terms transcode and encode may be used interchangeably herein. The encoder/transcoder 104 may receive content from the content source 102. The content may be in any one of a variety of formats, such as, for example, H.264, MPEG-4 Part 2, or MPEG-2. The encoder/transcoder 104 may convert the content from one video format to another video format, such as one format compatible with the playback devices of the service provider's users (e.g., computing device 110). The encoder/transcoder 104 may additionally segment the content into a plurality of segments. For example, content may be segmented into a series of 2-second segments.

When uncompressed video data is received, the encoder may encode the video (e.g., into a compressed format) using a compression technique prior to transmission. The content source 102 and the encoder/transcoder 104 may be co-located at a premises, located at separate premises, or associated with separate instances in the cloud. The encoder 104 may comprise any type of encoder including but not limited to: H.264/MPEG-AVC, H.265/MPEG-HEVC, MPEG-5 EVC, H.266/MPEG-VVC, AV1, VP9, Global motion compensation (GMC), etc. The encoder/transcoder 104 may transcode the content into one or more output streams. The one or more output streams may comprise video encoded with different resolutions and/or different bit rates.

The linear packager 106 may receive the content from the encoder/transcoder 104 or the content delivery system 170. For example, the linear packager 106 may receive the one or more output streams from the encoder/transcoder 104. The linear packager 106 may determine how the content is to be segmented and put together for delivery to the content delivery system 170.

The packager 106 may generate one or more ABR streams in different ABR streaming formats. The one or more ABR streams may comprise segments or fragments of video and the manifest. The manifest may indicate availability of the ABR stream and segments/fragments and information for requesting the segments/fragments (e.g., via a URL). The packager 106 may send the one or more ABR streams to the content delivery system 170.

The content delivery system 170 may comprise one or more computing devices such as a video recording system 123, packager 124, video origin 125, and metadata storage 126. The video recording system 123 may receive content from the linear packager 106 and may record or store the content in the content delivery system 170. Additionally, the video recording system 123 may manage metadata associated with the recorded content. The video recording system 123 may extract or generate metadata for a recorded content segment and store the metadata within metadata storage 126.

The packager 124 may package content segments for delivery to the computing device 110. For example, the packager 124 may receive a request for content from the computing device 110, and may retrieve content segments according to the request. The packager 124 may determine how the content is to be segmented and put together for delivery to and eventual playback by the computing device 110. As part of this process, the packager 124 may segment the content (such as in the event that the content has not yet been segmented) or may re-segment the content (such as in the event that the content had been previously segmented). The packager 124 may additionally insert one or more cues or markers into the content segments at which one or more additional segments, such as segments comprising an advertisement, may be inserted by an upstream client, server, or logical module, such as a component of the ad delivery system 171.

The video origin 125 may serve requests for the packager 124. The video origin 125 may also generate and send manifests associated with a content profile or particular content segments. The video origin 125 may create a manifest file associated with the content. For example, the manifest may comprise a DASH manifest. The manifest may comprise information describing various aspects of the associated content that may be useful for the computing device 110 to playback the content and/or for the content delivery system 170 to store and retrieve the content. For example, the manifest may indicate the availability of the segments comprising the content, the length of each segment, the number of segments, and/or the proper ordering of the segments necessary to cause playback of the content. The manifest may further include a network location (e.g., a hyper-text transfer protocol (HTTP) uniform resource locater (URL) link or other universal resource identifier (URI)) for each segment from which the segment may be downloaded, accessed, or retrieved. For example, the network location may indicate a location in storage of the video recording system 123, or another storage not shown.

The network locations included within the manifest may indicate more than one location or source. For example, the network location for segments corresponding to the content may reference a storage location of the content delivery system 170 while the network location for segments corresponding to an inserted advertisement may reference a location from the ad delivery system 171 (e.g., at an advertising server). The manifest may describe multiple versions (e.g., different quality levels) of the content, including corresponding information on those segments. For example, a manifest may describe multiple bit rate and/or resolution versions of the content. The manifest may be provided, such as by the packager 124, to the computing device 110 in response to a request to receive stored content. The computing device 110 may use the manifest file to determine the segments required to play the content or a segment/portion of the content and subsequently download the required segments using the network locations specified in the manifest file.

The computing device 110 may receive content from the content delivery system 170, such as from storage of the video recording system 123. The computing device 110 may request a content from the content delivery system 170, and may receive a manifest corresponding to the content, such as from the packager 124. The manifest may indicate storage locations for content segments of the content (e.g., URLs for content segments), which the computing device 110 may use to access or retrieve the content segments of the content.

In some cases, the content, the manifest, or both, may indicate advertisement insertion points for the content. For example, an advertisement insertion point may be indicated by an ad insertion marker, which may be within the corresponding manifest, or within the content retrieved from storage. The advertisement insertion point may indicate a location, with respect to content segments of the content, an advertisement may be inserted into the content (e.g., the content stream). In some cases, the advertisement insertion points may be indicated in metadata associated with the content, which may be delivered with the content, with the corresponding manifest or manifests, or as separate messages (e.g., between the content delivery system 170 and the computing device 110. For example, the ad insertion points may be indicated in SCTE 35 messages between the content delivery system 170 and the computing device 110.

The ad delivery system 171 may store ad segments and associated ad insertion rules for inserting into the content. The ad delivery system 171 may include an ad decisioning system 184. The ad decisioning system 184 may include rules for the insertion of ad segments into content. The rules may indicate ad segment types to be inserted into a content. The ad segment type may be based on the requested content, an ad break duration of the content, characteristics of the requesting computing device or associated user profile, and the like. The ad segment type may be, for example, a topic of the ad, a description of the ad, a creator or owner of the ad, and the like.

The rules may indicate an ad duration for a given ad break in the content. For example, the rules may indicate a total duration for a particular ad break in the content, such as a total time duration (e.g., 30 seconds), or a total number of ad segments for the ad insertion point. The ad duration may be based on the requested content, characteristics of the requesting computing device or associated user profile, and the like.

The rules may indicate location-based rules for ad insertion into content. For example, the rules may indicate a duration of an ad for inserting into the content according to distance the computing device 110 is away from a target object, which will be described in more detail below. The rules may indicate a version type of an ad for inserting into the content according to the distance the computing device 110 is away from a target object. For example, there may be multiple versions of an ad, where each version may include a different duration of the ad.

The ad decisioning system 184 may include an application programming interface (API) capable of receiving input from third-party users. For example, the third-party users may be content or ad providers. The input may include instructions for defining the rules described above.

The ad delivery system 171 may also include ad collection 186. The ad collection 186 may store the ads and ad segments available for playback by the computing device 110. For example, ad segments may be uploaded to the ad collection 186, such as via an API by an ad or content provider.

The computing device 110 may also include an MPD manipulator 182. The MPD manipulator may determine which ad segments to request for insertion into received content. For example, the MPD manipulator 182 may monitor the location of the computing device 110 in relation to a target object, and may determine an ad or ad type to select for inserting into the content. The MPD manipulator 182 may determine an ad insertion point in received content. The MPD manipulator 182 may determine a location of the computing device 110. For example, the computing device 110 may determine its location via various geolocation techniques, such as through GPS, network-related techniques, app-related techniques, proximity-inclusive techniques such as infrared (IR), low power Bluetooth (LP BT), Zigbee, and the like. The MPD manipulator 182 may also receive information indicative of a location of a target object, such as a traffic light or toll booth. For example, the target object may be a static object, and its location may be provided by a geo-mapping technique. In some cases, the target object may be capable of communications, such as via IoT communications, and may provide its location through communications.

The MPD manipulator 182 may determine an ad to insert based on the location of the computing device 110 with respect to the target object. For example, the MPD manipulator 182 may send an ad selection to an ad code database 180. The ad code database 180 may store ad codes corresponding to ads stored in the ad delivery 171. In some cases, the ad code database 180 may be a part of the computing device 110, while in some cases the ad code database 180 may be external to the computing device 110. The ad code database 180 may communicate with the ad delivery system 171 to request an ad according to the instructions of the MPD manipulator 182, and may receive from the ad delivery system 171 an ad for insertion. The ad may be inserted into the content by the MPD manipulator 18, such as by just-in-time packaging. The inserted ad may be sent to the display for playback by the computing device 110.

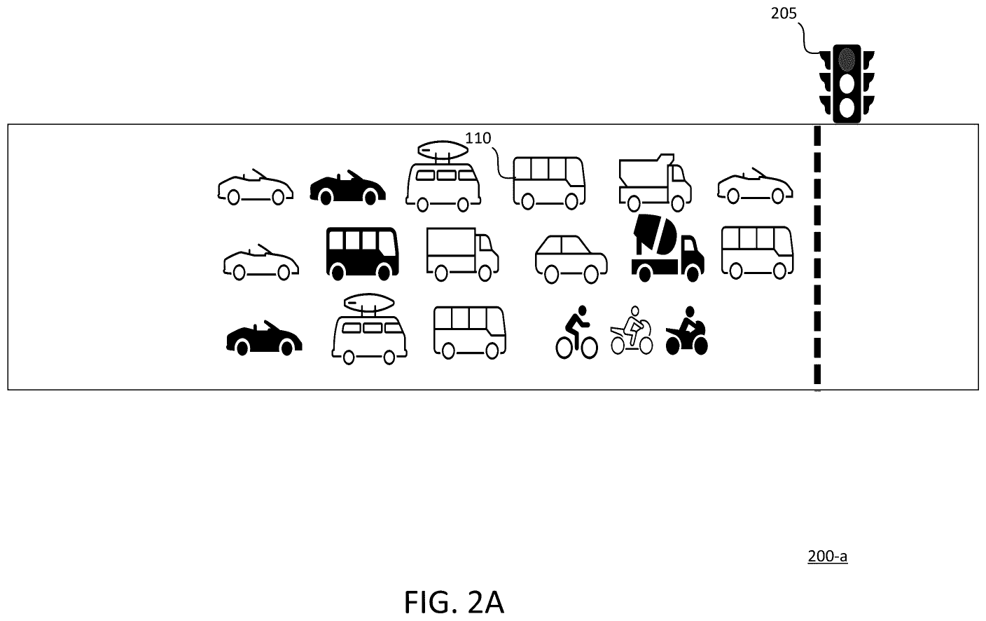

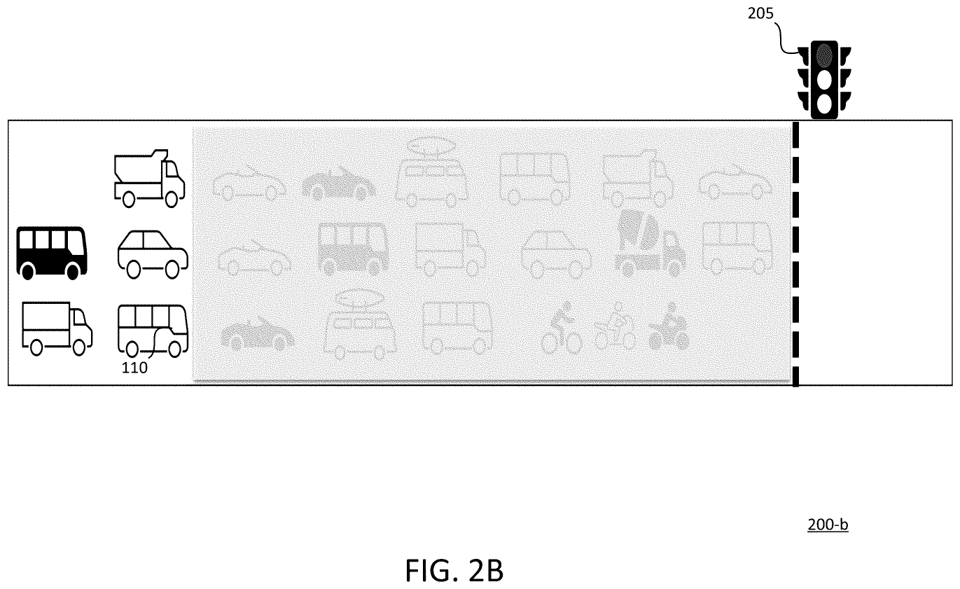

FIG. 2A shows an example system 200-a. The system 200-a may include a computing device, such as computing device 110 as described with reference to FIG. 1. The computing device 110 may be in geographical proximity to a target object 205. For example, the computing device 110 may be transported by a vehicle such as a car. In some cases, the computing device may be a part of, or integrated into, a vehicle. The vehicle may travel or reposition geographically, which may place the computing device 110 into geographical proximity to the target object 205.

The target object 205 may be a stationary object. The target object 205 may be a traffic-related object. For example, FIG. 2A shows the target object 205 as a traffic light. Another example, of the target object 205 may include a toll booth, a traffic gate, a traffic sign, and the like. In some cases, the target object 205 may be transportable or moveable, such as mobile traffic display, a construction barrier, and the like.

The target object 205 may be capable of providing location information to other entities. For example, the target object 205 may be capable of communicating with other entities via a telecommunications protocol, such as an IoT protocol, Bluetooth, Wi-Fi, other WLAN protocols, GPS, LTE, and the like. The target object 205 may communicate its geographic locations (e.g., geographic coordinates) to other entities of the system, which may be stored for other components to access or sent to other system entities. In some cases, the geographic location of the target object 205 may be defined by. For example, in cases where the target object 205 is statically positioned, the location of the target object 205 may be identified and stored for access by other components.

The computing device 110 may receive the location information of the target object 205. For example, the computing device 110 may subscribe or have access to a location based service (LBS) providing geographic locations for one or more target devices to subscribers or end users. The computing device 110 may also include information relating to the geographic location of the computing device 110, such as via an LBS service or GPS. The computing device 110 may determine a distance between the computing device 110 and the target object 205 from the respective location information. In the context of FIG. 2A, the target object 205 may be a traffic light, and the computing device 110 may be traveling in, or is, a vehicle. The vehicle may approach the traffic light, and the computing device 110 may determine the computing device 110 is a distance away from the traffic light. The computing device 110 may determine the distance meets a predefined threshold, or falls within a predefined range. For example, the computing device 110 may determine the computing device 110 may be within 20 yards from the traffic light, or may be within 10 to 20 yards from the traffic light. The computing device 110 may retrieve an advertisement for playback based on the distance between the computing device 110 and the traffic light. For example, the computing device 110 may be able to select different versions of an advertisement for playback. The ad delivery system (of FIG. 1) may store different advertisement versions according to the distance between the computing device 110 and the target object 205. For example, the ad delivery system may store a long version of an advertisement (e.g., 30 seconds), a medium version of the advertisement (e.g., 20 seconds), and a short version of the advertisement (e.g., 10). In some cases, the respective versions of the advertisement may include overlapping advertisement content segments. However, the shortened versions may include a lesser number of content segments compared to the high version, which in some cases may be considered a full version of the advertisement.

The rules maintained by the system may determine which version of the advertisement the computing device 110 requests. For example, the computing device 110 may request a long version, a medium version, a short version, etc., of the advertisement based on the distance of the computing device 110 (e.g., the distance meeting a predefined distance threshold or falling within a predefined distance range). For example, in FIG. 2A, the computing device 110 distance may fall within a predefined short range of the target object 205. The computing device 110 may determine to request a short version of the advertisement based on the determined short distance. In another example of FIG. 2B, the computing device 110 may determine the distance falls outside of the predefined short range, and instead may be a predefined medium distance or within a predefined medium range. The computing device 110 may request a medium version of the advertisement based on the determined medium distance or medium range.

In some cases, the distance determination, or ad insertion may be implemented based on a trigger or event occurring. For example, the computing device 110 may determine an advertisement insertion point in a content. For example, the content may receive a manifest corresponding to the content, and the content may indicate a location for inserting an advertisement, such as via an indicator or flag in the manifest. In some cases, the distance determination may be based on an event or status. For example, in the context of the target object 205 as a traffic light, the traffic light may include a status of the light. For example, the status may include a red light, a yellow light, a green light, etc. The traffic light may transmit information indicative of the status of the light. The computing device 110 may determine to implement a distance determination for the computing device 110 based on the status of the light. For example, the computing device 110 may implement the distance determination based on a red light status, which may indicate the computing device 110 is in traffic caused by the red light. In some cases, the computing device 110 may determine to insert an advertisement into the content based on the red light status. In another example, the computing device 110 may refrain from determining the distance, or refrain from inserting an advertisement, based on the status of the traffic light (e.g., a green light).

In another example, the computing device 110 may monitor a speed at which the computing device is travelling. The computing device 110 may determine whether to insert an advertisement based on the traveling speed of the computing device 110. For example, the computing device 110 may determine the travelling speed is within a speed range, or above or below a speed range. The computing device 110 may determine to insert an advertisement, or to implement a distance determination based on the speed. For example, if the speed is zero or near zero, the computing device 110 may determine the computing device is in traffic near the traffic light, and may determine to insert an advertisement. Alternatively, the computing device 110 may determine the speed of the computing device is above a threshold (e.g., 35 mph), and may determine to refrain from inserting an advertisement.

In some cases, the computing device 110 may determine to insert an advertisement based on an estimated time to reach the target object. For example, in the context of FIG. 2A, the computing device 110 may determine an estimated time the computing device may reach the traffic light. The computing device 110 may identify the distance away from the traffic light, the status of the traffic (e.g., a red light), a status duration of the traffic (e.g., 30 more seconds), an estimated number of vehicles ahead of the computing device 110, and the like, to generate an estimated time to reach the traffic light (e.g., approximately one minute). The computing device 110 may determine whether the insert an advertisement based on the estimated time. Further, the computing device 110 may request a version of the advertisement based on the estimated time (e.g., a long duration version, which may be approximately 45 seconds).

In some cases, the computing device 110 may identify a distance between itself and another object, such as another computing device. For example, the computing device 110 may have access to location information of other nearby computing devices, and may determine another computing device is located between itself and the traffic light. The computing device 110 may determine to insert an advertisement, or to implement a distance determination, based on the identification of other computing device in the area.

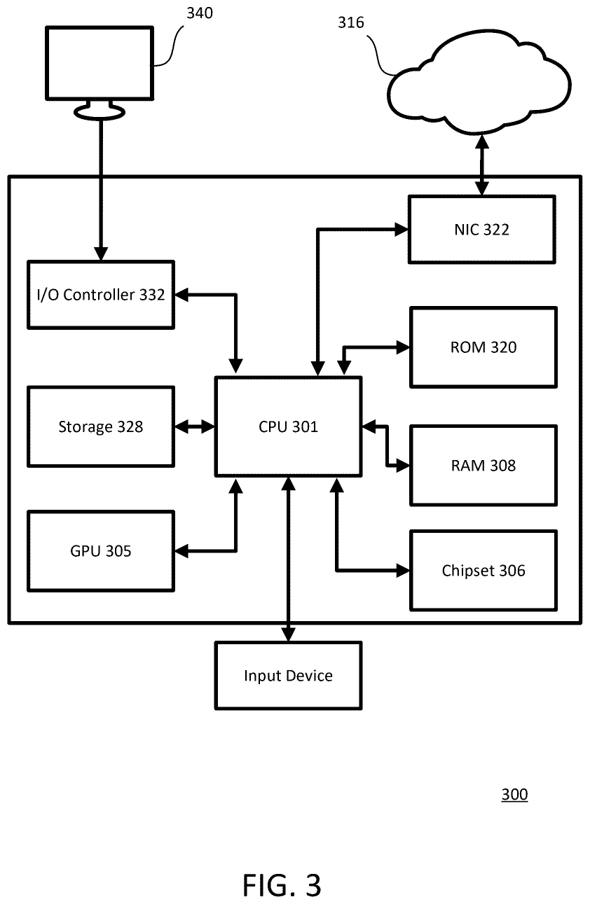

FIG. 3 depicts a computing device 300 that may be used in various aspects, such as the components shown in FIGS. 1 and 2, which may be utilized to execute any aspects of the methods described herein. For example, some or all of the components of FIG. 1 or 2 can be a part of a computing device, or each component may be a computing device. The computing device 300 may include a baseboard, or “motherboard,” which is a printed circuit board to which a multitude of components or devices may be connected by way of a system bus or other electrical communication paths. One or more central processing units (CPUs) 301 may operate in conjunction with a chipset 306. The CPU(s) 301 may be standard programmable processors that perform arithmetic and logical operations necessary for the operation of the computing device 300.

The CPU(s) 301 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 301 may be augmented with or replaced by other processing units, such as GPU(s) 305. The GPU(s) 305 may comprise processing units specialized for but not necessarily limited to highly parallel computations, such as graphics and other visualization-related processing.

A chipset 306 may provide an interface between the CPU(s) 301 and the remainder of the components and devices on the baseboard. The chipset 306 may provide an interface to a random access memory (RAM) 308 used as the main memory in the computing device 300. The chipset 306 may further provide an interface to a computer-readable storage medium, such as a read-only memory (ROM) 320 or non-volatile RAM (NVRAM) (not shown), for storing basic routines that may help to start up the computing device 300 and to transfer information between the various components and devices. ROM 320 or NVRAM may also store other software components necessary for the operation of the computing device 300 in accordance with the aspects described herein.

The computing device 300 may operate in a networked environment using logical connections to remote computing nodes and computer systems through local area network (LAN) 316. The chipset 306 may include functionality for providing network connectivity through a network interface controller (NIC) 322, such as a gigabit Ethernet adapter. A NIC 322 may be capable of connecting the computing device 300 to other computing nodes over a network 316. It should be appreciated that multiple NICs 322 may be present in the computing device 300, connecting the computing device to other types of networks and remote computer systems.

The computing device 300 may be connected to a mass storage device 328 that provides non-volatile storage for the computer. The mass storage device 328 may store system programs, application programs, other program modules, and data, which have been described in greater detail herein. The mass storage device 328 may be connected to the computing device 300 through a storage controller 324 connected to the chipset 306. The mass storage device 328 may consist of one or more physical storage units. A storage controller 324 may interface with the physical storage units through a serial attached SCSI (SAS) interface, a SATA interface, a fiber channel (FC) interface, or other type of interface for physically connecting and transferring data between computers and physical storage units.

The computing device 300 may store data on a mass storage device 328 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 328 is characterized as primary or secondary storage and the like.

For example, the computing device 300 may store information to the mass storage device 328 by issuing instructions through a storage controller 324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 300 may further read information from the mass storage device 328 by detecting the physical states or characteristics of one or more particular locations within the physical storage units.

In addition to the mass storage device 328 described herein, the computing device 300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 328 depicted in FIG. 3, may store an operating system utilized to control the operation of the computing device 300. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 328 may store other system or application programs and data utilized by the computing device 300.

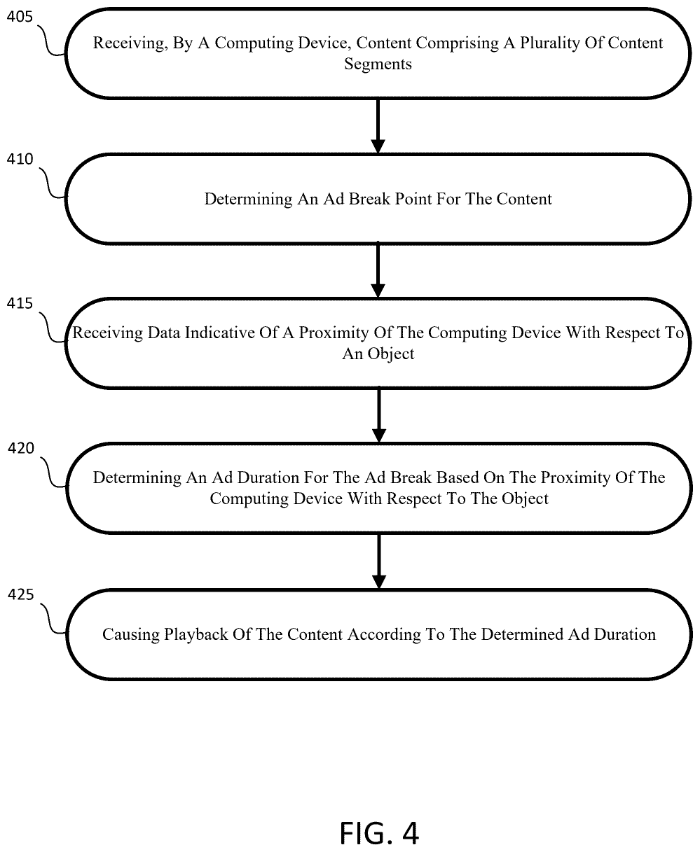

The mass storage device 328 or other computer-readable storage media may also be encoded with computer-executable instructions, which, when loaded into the computing device 300, transforms the computing device from a general-purpose computing system into a special-purpose computer capable of implementing the aspects described herein. These computer-executable instructions transform the computing device 300 by specifying how the CPU(s) 304 transition between states, as described herein. The computing device 300 may have access to computer-readable storage media storing computer-executable instructions, which, when executed by the computing device 300, may perform the methods described in relation to FIGS. 4-6.

A computing device, such as the computing device 300 depicted in FIG. 3, may also include an input/output controller 332 for receiving and processing input from a number of input devices, such as a keyboard, a mouse, a touchpad, a touch screen, an electronic stylus, or other type of input device (e.g., a remote control via infrared, Bluetooth, and the like).

Similarly, an input/output controller 332 may provide output to a display 340, such as a computer monitor, a flat-panel display, a digital projector, a printer, a plotter, or other type of output device. It will be appreciated that the computing device 300 may not include all of the components shown in FIG. 3, may include other components that are not explicitly shown in FIG. 3, or may utilize an architecture completely different than that shown in FIG. 3.

As described herein, a computing device may be a physical computing device, such as the computing device 300 of FIG. 3. A computing node may also include a virtual machine host process and one or more virtual machine instances. Computer-executable instructions may be executed by the physical hardware of a computing device indirectly through interpretation and/or execution of instructions stored and executed in the context of a virtual machine.

FIG. 4 shows an example method. The method may comprise a computer implemented method. The method may be implemented by one or more devices (e.g., computing devices, servers) and/or services disclosed herein, such as the devices, storage, and/or services of FIG. 1, 2A, or 2B. One or more of the steps of the method may be implemented by the computing device 110, and/or other components of the system 100.

At Step 405, content comprising a plurality of segments may be received. The content may be received by a computing device, such as computing device 110 of FIG. 1. The computing device may be a playback device. The content may include streaming content, for example. At Step 410, an ad break point may be determined for the content. The content may include a plurality of content segments, and one or more ad breaks. The one or more ad breaks may be indicated by respective markers embedded within the one or more content segments, or a respective manifest may indicate the one or more ad breaks within the content.

At Step 415, data indicative of a proximity of the computing device with respect to an object may be received. The data may be based on geolocation data of the computing device, geolocation data of the object, and the like. For example, the data may be GPS data. In some cases, the data may indicate the computing device is within a proximity threshold with respect to the object. In some cases, the object may be a traffic light or toll booth.

At Step 420, an ad duration for the ad break may be determined. The ad duration may be determined based on the proximity of the computing device with respect to the object. The duration may be based on the proximity meeting or exceeding a proximity threshold. The duration may be based on the proximity meeting or falling below a proximity threshold. The duration may be further based on a status of the object, such as a green light or a red light status. The duration may be based on a proximity of other computing devices to the object. The duration may be based on an estimated for the computing device to reach the object.

At Step 425, playback of the content according to the determined ad duration may be caused. The computing device may select one or more ad segments according to the determined ad duration. The computing device may send a request for one or more ad segments according to the determined ad duration.

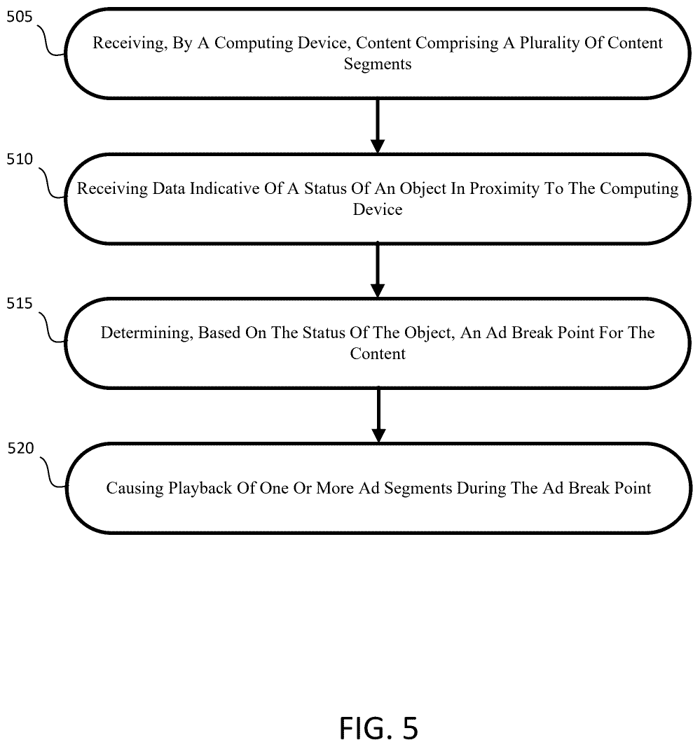

FIG. 5 shows an example method. The method may comprise a computer implemented method. The method may be implemented by one or more devices (e.g., computing devices, servers) and/or services disclosed herein, such as the devices, storage, and/or services of FIG. 1, 2A, or 2B. One or more of the steps of the method may be implemented by the computing device 110, and/or other components of the system 100.

At Step 505, content may be received by a computing device. The content may comprise a plurality of content segments. The computing device may be a playback device. At Step 510, data indicative of a status of an object may be received. The data may be received by the computing device. The object may be in proximity to the computing device. The proximity of the computing device to the object may meet or exceed a proximity threshold. The proximity of the computing device to the object may be less than a proximity threshold. The status may be indicative of a dynamic ad break for the content. The status may be indicative of a normal ad break for the content.

At Step 515, an ad break point may be determined for the content. The ad break point may be determined based on the status of the object. The ad break point may be determined based on a dynamic indication of the status of the object. The ad break point may be different from a scheduled ad break point in the content. An ad duration for the ad break may also be determined. The ad duration may be determined based on the proximity of the computing device with respect to the object. The duration may be based on the proximity meeting or exceeding a proximity threshold. The duration may be based on the proximity meeting or falling below a proximity threshold. The duration may be further based on a status of the object, such as a green light or a red light status. The duration may be based on a proximity of other computing devices to the object. The duration may be based on an estimated time or distance for the computing device to reach the object.

At Step 520, playback of one or more ad segments during the ad break point may be caused. The computing device may select the one or more ad segments based on the determined ad break. The computing device may select one or more ad segments according to the determined ad duration. The computing device may send a request for one or more ad segments according to the determined ad break. The computing device may insert the one or more ad segments within the content and according to the determined ad break. The one or more ad segments may comprise a version of a plurality of versions, where the version is based on the proximity of the computing device with respect to the object.

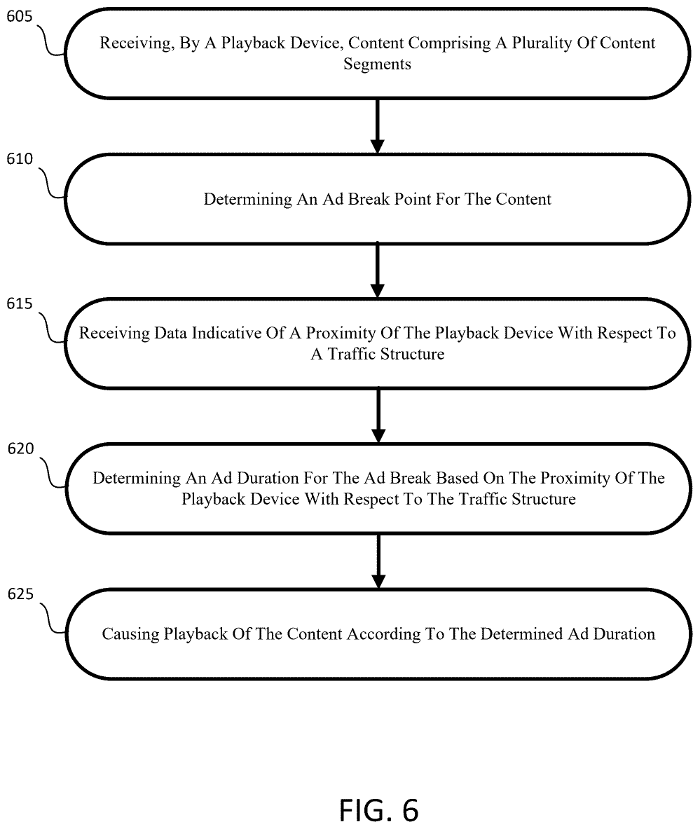

FIG. 6 shows an example method. The method may comprise a computer implemented method. The method may be implemented by one or more devices (e.g., computing devices, servers) and/or services disclosed herein, such as the devices, storage, and/or services of FIG. 1, 2A, or 2B. One or more of the steps of the method may be implemented by the computing device 110, and/or other components of the system 100.

At Step 605, content comprising a plurality of segments may be received. The content may be received by a playback device. The content may include streaming content, for example. At Step 610, an ad break point may be determined for the content. The content may include a plurality of content segments, and one or more ad breaks. The one or more ad breaks may be indicated by respective markers embedded within the one or more content segments, or a respective manifest may indicate the one or more ad breaks within the content.

At Step 615, data indicative of a proximity of the playback device with respect to a traffic structure may be received. The data may be based on geolocation data of the playback device, geolocation data of the traffic structure, and the like. For example, the data may be GPS data. In some cases, the data may indicate the playback device is within a proximity threshold with respect to the traffic structure. In some cases, the traffic structure may be a traffic light or toll booth.

At Step 620, an ad duration for the ad break may be determined. The ad duration may be determined based on the proximity of the playback device with respect to the traffic structure. The duration may be based on the proximity meeting or exceeding a proximity threshold. The duration may be based on the proximity meeting or falling below a proximity threshold. The duration may be further based on a status of the traffic structure, such as a green light or a red light status. The duration may be based on a proximity of other playback devices to the object. The duration may be based on an estimated time or distance for the playback device to reach the traffic structure.

At Step 625, playback of the content according to the determined ad duration may be caused. The playback device may select one or more ad segments according to the determined ad duration. The playback device may send a request for one or more ad segments according to the determined ad duration.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
receiving, by a computing device, content comprising a plurality of content segments;
determining an ad break point for the content;
receiving data indicative of a proximity of the computing device with respect to an object;
determining an ad duration for the ad break based on the proximity of the computing device with respect to the object; and
causing playback of the content according to the determined ad duration.

2. The method of claim 1, further comprising:
selecting one or more ad segments according to the determined ad duration.

3. The method of claim 1, further comprising:
determining, based on the proximity of the computing device, an estimated time for the computing device to reach the object; wherein determining the ad duration is further based on the estimated time.

4. The method of claim 1, further comprising:
receiving data indicative of a second proximity of a second computing device with respect to the object; wherein determining the ad duration is further based on the second proximity.

5. The method of claim 4, wherein the second computing device is closer in proximity to the object.

6. The method of claim 1, further comprising:
receiving information indicative of a status of the object, wherein the determining the ad duration is further based on a status of the object.

7. The method of claim 6, wherein determining the ad break is based on the status of the object.

8. The method of claim 1, further comprising:
sending a request for ad segments according to the determined ad duration; and
receiving the one or more ad segments.

9. The method of claim 1, wherein the computing device comprises a playback device.

10. The method of claim 1, wherein the object comprises a traffic light or a toll booth.

11. A method comprising:
receiving, by a computing device, content comprising a plurality of content segments;
receiving data indicative of a status of an object in proximity to the computing device;
determining, based on the status of the object, a break point for the content; and
causing playback of one or more ad segments during the break point.

12. The method of claim 11, wherein the status of the object comprises a first state indicative of a dynamic ad break, and wherein the determining the ad break point is based on the first state.

13. The method of claim 11, wherein the status comprises a second state indicative of a scheduled ad break, and wherein the determining the ad break is based on the second state.

14. The method of claim 11, further comprising:
determining an ad duration for the ad break based on the proximity of the computing device with respect to the object.

15. The method of claim 14, further comprising:
sending a request for ad segments according to the determined status of the object; and
receiving the one or more ad segments, wherein the one or more ad segments comprise a version of a plurality of versions, and wherein the version is based on the proximity of the computing device with respect to the object.

16. The method of claim 11, wherein the object comprises a traffic light, and wherein the status comprises a light status of the traffic light.

17. A method comprising:
receiving, by a playback device, content comprising a plurality of content segments;
receiving data indicative of a proximity of the playback device with respect to a traffic structure;
determining a duration for playback of content based on the proximity of the playback device with respect to the traffic structure; and
causing playback of the content according to the determined duration.

18. The method of claim 17, further comprising:
determining, based on the proximity of the playback device, an estimated time for the playback device to reach the object; wherein determining the ad duration is further based on the estimated time.

19. The method of claim 17, further comprising:
receiving data indicative of a second proximity of a second playback device with respect to the traffic structure; wherein determining the ad duration is further based on the second proximity.

20. The method of claim 17, further comprising:
receiving information indicative of a status of the traffic structure, wherein the determining the ad duration is further based on status of the traffic structure.
